(19) United States
(12) Patent Application Publication
(10) Pub. No.: US 2014/0075217 A1
(43) Pub. Date: Mar. 13, 2014

(54) Power Saving Network Controller

(71) Applicants: Kin-Yee Wong, Ottawa (CA); Joseph Rorai, Kanata (CA)

(72) Inventors: Kin-Yee Wong, Ottawa (CA); Joseph Rorai, Kanata (CA)

(73) Assignee: ALCATEL-LUCENT CANADA INC., Kanata (CA)

(21) Appl. No.: 13/610,920

(22) Filed: Sep. 12, 2012

(51) Int. Cl. G06F 1/32; G06F 1/26

(52) U.S. Cl. 713/320; 713/300

(57) ABSTRACT

A method and system are provided for reducing power usage in a telecommunications network. An intelligent network manager within a network operations center determines whether to change the power usage of the network, such as reducing power usage at limes of low network activity. The network operations center is in communication with the network elements of the network, and using the communication channels between the network operations center and the network elements the intelligent network manager instructs various ones of the network elements to operate at a lower capacity or even not at all.

### FIELD OF INVENTION

This invention relates to reduction of power consumption when operating telecommunications networks.

### BACKGROUND

Energy and power consumption are increasingly becoming a significant business issue as energy costs and environmental impact are becoming more important in business models. At the same time, the cost of providing energy may vary. The latter is becoming more common as utilities attempt to address finite energy generation by reducing demand for peak energy. The cost of energy may vary with time and/or geography. For example, there is often less demand for electricity late at night than in the middle of the day, and in an attempt to shift consumption of electricity to off-peak hours utilities may lower the cost of the electricity at night and raise the cost of the electricity during the day.

A method which allowed the power usage of network elements within a telecommunications network to be varied would provide the potential to realize environmental and monetary advantages.

### SUMMARY

According to one aspect, an apparatus is provided, the apparatus including an interface and a data storage device storing computer program instructions. The apparatus also includes a processor communicatively coupled to the interface and to the data storage device. The processor, in cooperation with the data storage device, is configured to execute the computer program instructions, which when executed on the processor cause the processor to perform operations. The operations include determining whether power usage within a telecommunications network having a plurality of network elements is to be changed. The operations also include determining at least one of the network elements to reconfigure so as to change its power usage and sending to the determined at least one network element instructions to reconfigure the network element so as to change power usage of the network element, if it is determined that power usage within the network is to be changed.

According to another aspect, a method performed by a network operations center of a telecommunications network, the network comprising a plurality of network elements, is provided. An intelligent network manager (INM) within a network operations center determines whether power usage within the network is to be changed. If the INM determines that power usage within the network is to be changed, then the INM determines at least one of the network elements to reconfigure so as to change its power usage and sends to the determined at least one network element instructions to reconfigure the network element so as to change power usage of the network element.

According to another aspect, an intelligent network manager (INM) within a network operations center of a telecommunications network is provided, the network comprising a number of network elements. The INM includes logic for determining whether power usage within the network is to be changed. The INM also includes logic for, in the event that the INM determines that power usage within the network is to be changed, determining at least one of the network elements to reconfigure so as to change its power usage, and sending to the determined one or more network element instructions to reconfigure the network element so as to change power usage of the network element. At least some of the logic may be implemented as hardware.

The methods of embodiments of the invention may be stored as logical instructions on a non-transitory computer-readable storage medium in a form executable by a computer processor.

Embodiments of the invention allow the power usage of a network to be reduced in response to a number of factors, such as traffic needs and the cost of power.

### BRIEF DESCRIPTION OF THE DRAWINGS

The features and advantages of embodiments of the invention will become more apparent from the following detailed description of the preferred embodiment(s) with reference to the attached figures, wherein:

FIG. 1 is a portion of an example telecommunication network;

FIG. 2 is a flowchart of a method carried out by the intelligent network manager of FIG. 1 according to one embodiment of the invention; and

FIG. 3 is a block diagram of a computing environment according to one embodiment of the invention.

It is noted that in the attached figures, like features bear similar labels.

### DETAILED DESCRIPTION OF THE PREFERRED EMBODIMENTS

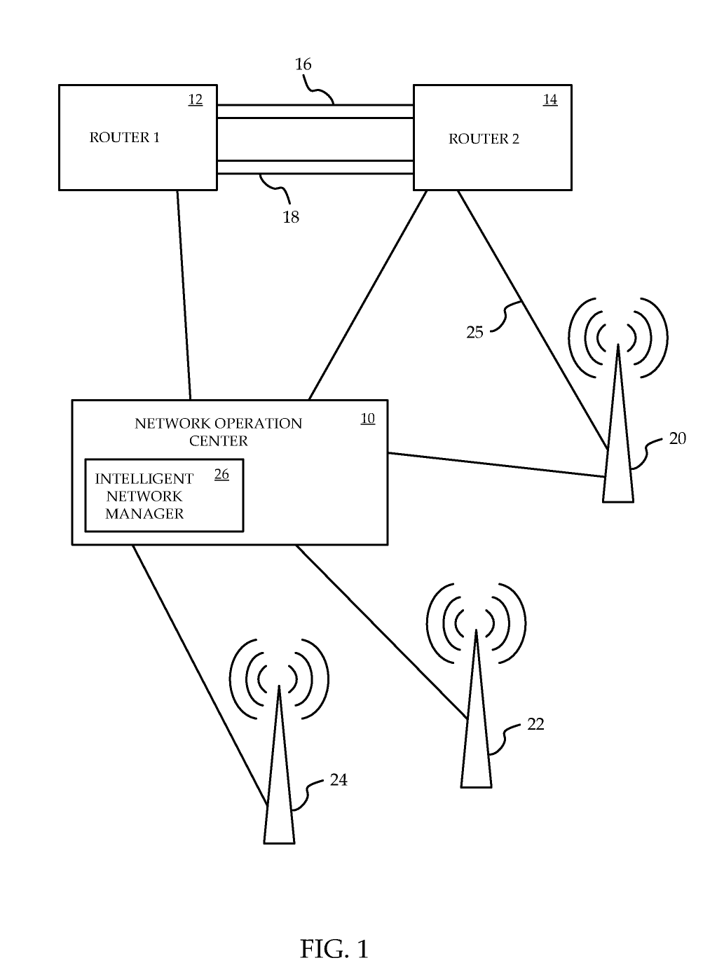

Referring to FIG. 1, a portion of an example telecommunications network is shown. A network operation center 10 is in communication through communication channels to a first router 12 and a second router 14. Linking the two routers 12 and 14 are a first link 16 and a second link 18. The network operation center 10 is also in communication with three base stations 20, 22, and 24 through respective communication channels. A link 25 also exists between the base station 20 and the second router 14. The routers and base stations are collectively referred to herein as network elements. The communication channels between the network operation center 10 and the various network elements of the telecommunications network allow the network operation center 10 to communicate with the various network elements. An interface for monitor and control is present on all network elements and the network operation center 10 can control the network elements through these interfaces, for example by sending SNMP or CLI commands to the interfaces. These communication channels can be either physical connections or wireless connections, or a combination of both.

The telecommunications network shown in FIG. 1 is only an example network, used to assist in illustrating the methods carried out by the network controller 10. There may of course be more than two routers, with various numbers of links between pairs of routers, more or less than three base stations, or neither of one of these types of network elements. If both routers and base stations are present, there may or may not be links between any number of base stations and any number of routers.

The network operation center 10 includes an intelligent network manager 26 comprising logic for carrying out the methods described below. The logic of the intelligent network manager 26 is preferably implemented as logical instructions for carrying out the method below and is in the form of software. Alternatively, the logic of the intelligent network manager may be implemented as hardware, such as an ASIC, another type of integrated circuit, or circuitry, or as a combination of software or hardware. If in the form of software, the logical instructions may be stored on a non-transitory computer-readable storage medium in a form executable by a computer processor.

Broadly, the intelligent network manager 26 comprises logic for determining whether power usage within the network is to be changed. If the INM determines that power usage within the network is to be changed, then the INM determines at least one of the network elements to reconfigure so as to change its power usage, and sends to the determined at least one network element instructions to reconfigure the network element so as to change power usage of the network element.

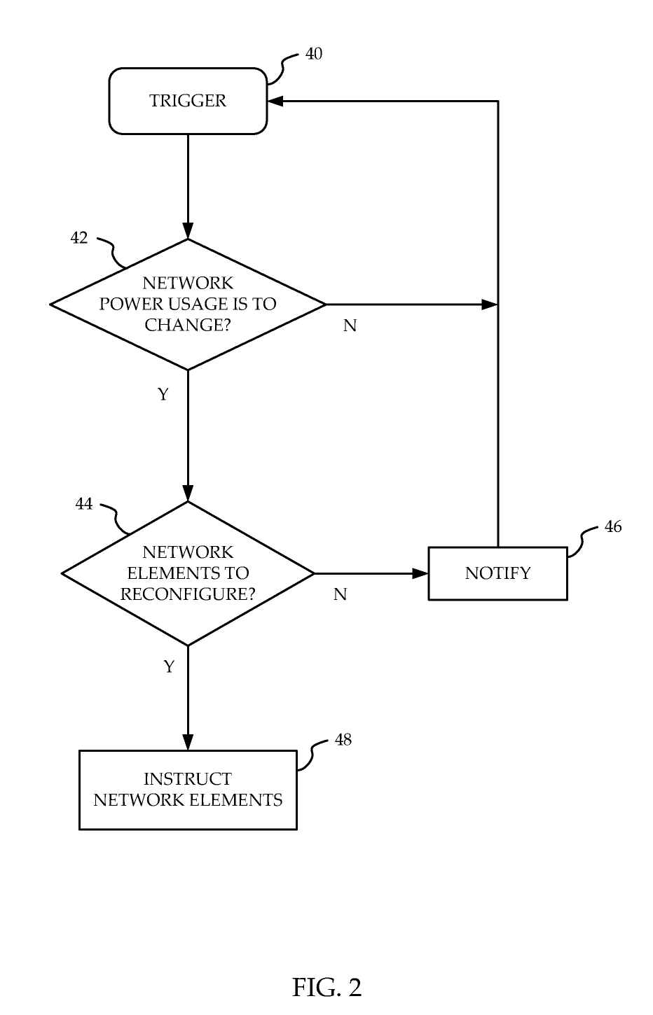

Referring to FIG. 2, a flowchart of a method carried out by the intelligent network manager 26 according to one embodiment of the invention is shown. At step 40 the method is triggered. The method carried out by the Intelligent Network Manager 26 may be triggered in a number of ways, such as at a fixed periodicity, when specified times of day are reached, when the amount of traffic falls below a threshold for a specified amount of time, when the cost of power changes, or when total power usage has surpassed a set threshold in a certain period. Combinations of these triggers can also be used, such as starting the method upon expiry of a tinier or when the cost of power changes, whichever occurs first.

At step 42 the Intelligent Network Manager 26 determines whether the power usage of the telecommunications network is to be changed. One or more criteria can be used by the Intelligent Network Manager 26 in making this determination, such as the cost of power, low network utilization, less critical network usage (e.g. night time versus core business hours), or user configurations. For example, the Intelligent Network Manager 26 may decide to reduce network power usage if the real-time cost of electricity (i.e. cents per kWh) surpasses a threshold and some users have configured their usage as being able to tolerate delays in order to avoid higher costs. As another example, the Intelligent Network Manager 26 may decide to change network power usage if it detects that the current time of day is within a predefined period, such as reducing power at night since less network capacity and hence less power is usually needed. As yet another example, the Intelligent Network Manager 26 may decide to reduce network power usage if it detects that the current usage of the network falls below a threshold, and that therefore less network capacity and hence less power is needed.

If the Intelligent Network Manager 26 determines that the power usage of the telecommunications network is not to be changed, then the Intelligent Network Manager 26 simply awaits the next triggering event. Examples situations which cause the Intelligent Network to determine that the power usage of the network is not to change are if the network is already in a low power usage state when the cost of power exceeds a threshold, or if the cost of power exceeds a threshold but network usage is still very high and customers have expressed preference for maintaining performance instead of savings cost. However if the Intelligent Network Manager 26 determines that the power usage of the telecommunications network is to be changed, then at step 44 the Intelligent Network Manager 26 determines which network elements, if any, are to have their power usage reduced. For example, some base stations whose coverage overlaps that of other base stations can be shut down. As another example, routers can use only one link of two between them for carrying traffic, shutting down or placing in standby mode the port leading to the second link. As yet another example, a router may have the ability to adjust its own capabilities in order to reduce its own power usage, such as disclosed in U.S. patent application Ser. No. 12/984,060, the contents of which are herby incorporated by reference. Using knowledge of the telecommunications network and of its constituent network elements, the Intelligent Network Manager 26 determines which network elements, if any, are to have their power usage reduced, and in what way.

The Intelligent Network Manager 26 may determine that no network elements can be sufficiently reconfigured to achieve the desired change in network power usage. For example, based on the system options available in hardware or software, the network elements may already be in the lowest power sate possible for maintaining minimum network connectivity, service level agreements, or desired coverage. In such a case, the Intelligent Network Manager 26 awaits the next triggering event, although the Intelligent Network Manager 26 may also produce a notification at step 46 that the power usage of the network was to be changed but that no sufficient change of the network could be found.

If the Intelligent Network Manager 26 determines network elements that can be changed, then at step 48 the Intelligent Network Manager 26 reconfigures the appropriate network elements by sending instructions to those network elements over the communication channels connecting the network operation center 10 to the network elements, such as by using SNMP messages.

Example implementations will be given using the example telecommunications network of FIG. 1. In a first example, the telecommunications network includes cellular towers 20, 22, and 24. In densely populated areas, such as the downtown area of a city, cellular towers often have cells which overlap. These can be macrocells, metrocells/small cells, or picocells, for example. During the evening the usage of the area may drop significantly and overlapping coverage may not be needed. If the Intelligent Network Manager 26 determines at step 42 of FIG. 2 that the power usage may be reduced because of reduced traffic, then at step 44 the Intelligent Network Manager 26 may determine that cellular tower 22 can be powered down without significantly affecting network usage. The Intelligent Network Manager 26 could either power down the entire cellular tower 22, or some of the supporting equipment such as cell site routers, switches, HVAC systems, and power systems. The network throughput and reliability may be diminished, but these may not be required during off peak hours, and the power consumption of the telecommunications network may be reduced.

As a second example, consider a telecommunications network in which parallel links exist between some routers, such as shown by links 16 and 18 in FIG. 1. During core business hours the data usage of the network may require these parallel links to deliver the desired volume of network traffic. However during periods of low utilization, the Intelligent Network Manager 26 may decide at step 42 that it is advantageous to reduce the power usage of the telecommunications network without significantly affecting traffic flow. At step 44 the Intelligent Network Manager 26 determines that the power usage of the network can be reduced by powering down one or more of the parallel links, such as link 18 in FIG. 1. At step 48 the Intelligent Network Manager 26 instructs the routers 12 and 14 to power down the link 18, such as by reducing power to ports and cards required for link 18, and to use only one of the two parallel links connecting the routers.

Of course the method also applies when the power usage of the telecommunications network is to be increased again, such as when more capacity is needed. The Intelligent Network Manager 26 reconfigures the various network elements to operate at higher capacity and hence at which higher power usage by sending them instructions via the appropriate communication channels.

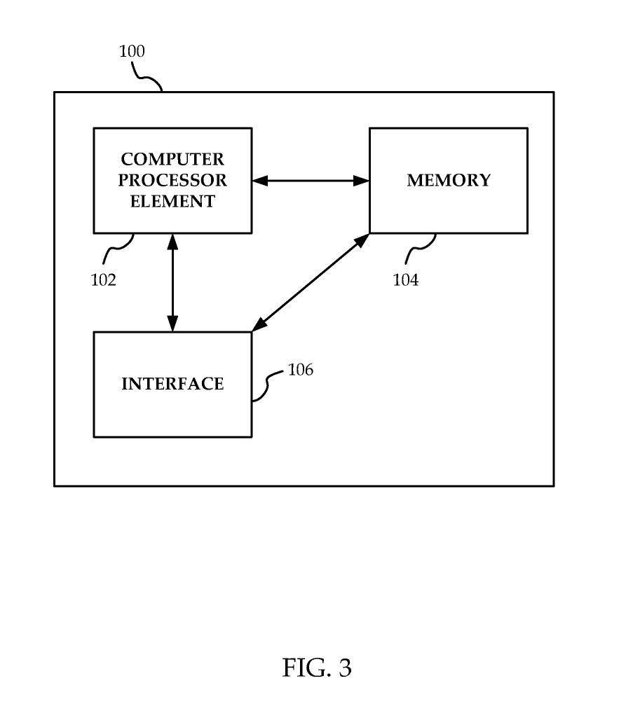

Referring to FIG. 3, a block diagram of a network operation center processor assembly suitable for use in performing functions described herein. Processor assembly 100 includes a computer processor element 102 (e.g. a central processing unit and/or other suitable processor(s)). The computer processor element 102 has access to a memory 104 (e.g. random access memory, read only memory, and the like). The processor element 102 and the memory 104 are also in communication with an interface comprising various I/O devices 106 (e.g. a user input device (such as a keyboard, a keypad, a mouse, and the like), an user output device (such as a display, a speaker, and the like), an input port, an output port, a receiver, a transmitter, and a storage device (such a tape drive, a floppy drive, a hard disk, a compact disk drive, and the like)). In one embodiment, the intelligent network manager 26 is implemented as software instructions loaded into the memory 104 and causing the computer processor element 102 to execute the methods described above.

The embodiments presented are exemplary only and persons skilled in the art would appreciate that variations to the embodiments described above may be made without departing from the spirit of the invention. The scope of the invention is solely defined by the appended claims.

I/We claim:

1. An apparatus comprising:
an interface;
a data storage device storing computer program instructions; and
a processor communicatively coupled to the interface and to the data storage device, the processor, in cooperation with the data storage device, configured to execute the computer program instructions, which when executed on the processor cause the processor to perform operations comprising:
determining whether power usage within a telecommunications network having a plurality of network elements is to be changed; and
if it is determined that power usage within the network is to be changed:
determining at least one of the network elements to reconfigure so as to change its power usage; and
sending to the determined at least one network element instructions to reconfigure the network element so as to change power usage of the network element.

2. The apparatus of claim 1 wherein determining whether power usage within the network is to be changed comprises determining that power usage within the network is to be changed if the current time of day is within a predefined period.

3. The apparatus of claim 1 wherein determining whether power usage within the network is to be changed comprises determining that power usage within the network is to be reduced if the current usage of the network is below a threshold.

4. The apparatus of claim 1 wherein determining whether power usage within the network is to be changed comprises determining that power usage within the network is to be reduced if the real-time cost of electricity surpasses a threshold.

5. The apparatus of claim 1 wherein sending instructions to the determined at least one network element comprises sending instructions to power down a cellular tower.

6. The apparatus of claim 1 wherein sending instructions to the determined at least one network element comprises sending instructions to power down supporting equipment of a cellular tower.

7. The apparatus of claim 1 wherein sending instructions to the determined at least one network element comprises sending instructions to a router to reduce its own power usage.

8. The apparatus of claim 1 wherein sending instructions to the determined at least one network element comprises sending instructions to two routers to use only one of two parallel links connecting the routers.

9. A method performed by a network operations center of a telecommunications network, the network comprising a plurality of network elements, comprising:
determining by an intelligent network manager (INM) within the network operations center whether power usage within the network is to be changed; and
if the INM determines that power usage within the network is to be changed:
determining, by the INM, at least one of the network elements to reconfigure so as to change its power usage; and
sending from the INM to the determined at least one network element instructions to reconfigure the network element so as to change power usage of the network element.

10. The method of claim 9 wherein determining whether power usage within the network is to be changed comprises determining that power usage within the network is to be changed if the current time of day is within a predefined period.

11. The method of claim 9 wherein determining whether power usage within the network is to be changed comprises determining that power usage within the network is to be changed if the current usage of the network is below a threshold.

12. The method of claim 9 wherein determining whether power usage within the network is to be changed comprises determining that power usage within the network is to be changed if real-time cost of electricity surpasses a threshold.

13. The method of claim 9 wherein sending instructions to the determined at least one network element comprises sending instructions to power down a cellular tower.

14. The method of claim 9 wherein sending instructions to the determined at least one network element comprises sending instructions to power down supporting equipment of a cellular tower.

15. The method of claim 9 wherein sending instructions to the determined at least one network element comprises sending instructions to a router to reduce its own power usage.

16. The method of claim 9 wherein sending instructions to the determined at least one network element comprises sending instructions to two routers to use only one of two parallel links connecting the routers.

17. An intelligent network manager (INM) within a network operations center of a telecommunications network comprising a plurality of network elements, the INM comprising logic for:
determining whether power usage within the network is to be changed; and
if the INM determines that power usage within the network is to be changed:
determining at least one of the network elements to reconfigure so as to change its power usage; and
sending to the determined at least one network element instructions to reconfigure the network element so as to change power usage of the network element.

18. The INM of claim 17 where at least some of the logic is implemented as hardware.

19. The INM of claim 17 wherein sending instructions to the determined at least one network element comprises sending instructions to power down supporting equipment of a cellular tower.

20. The INM of claim 17 wherein sending instructions to the determined at least one network element comprises sending instructions to a router to reduce its own power usage.
